(19) United States
(12) Patent Application Publication
(10) Pub. No.: US 2001/0056448 A1
(43) Pub. Date: Dec. 27, 2001

(54) Document modifying system, document transmission system utilizing the modifying system, document modifying method and medium

(76) Inventor: Kazuhiro Takeda, Kawasaki (JP)

Correspondence Address: STAAS & HALSEY LLP, 700 11TH STREET, NW, SUITE 500, WASHINGTON, DC, 20001, US

(21) Appl. No.: 09/859,480

(22) Filed: May 18, 2001

(30) Foreign Application Priority Data
Dec. 6, 2000 (JP) 2000-371970

(51) Int. Cl. G06F 15/00

(52) U.S. Cl. 707/515; 707/513

(57) ABSTRACT

A technology is capable of automatically modifying a text based on a rule and a syntax corresponding to a destination terminal and Group when transmitting the text, thereby relieving a load on a sender to smoothly exchange the information. A document modifying system (21) includes a recording unit (17) for recording a document creation standard corresponding to a destination of a document, and a modifying unit (11) for detecting a document unconformable with the document creation standard for the document destination, and modifying the document in conformity with the document creation standard.

### BACKGROUND OF THE INVENTION

The present invention relates to an auto document modifying system.

Information exchanges making use of mail/NetNews etc. are getting more and more active in the Internet that has been rapidly spreading over the recent years. Tools for those information exchanges solidify their positions in the business sector.

In the case of delivering a text to the mail/NetNews etc., however, it is required that the text be modified in conformity with a syntax and a rule adapted to a destination terminal or Group to which the text is transmitted. Accordingly, if the information sender does not conform with that rule, the sender might cause a confusion on a receiving side and might hinder smooth communications.

Therefore, the text has hitherto been created and transmitted in consideration of the text syntax and rule corresponding to the destination terminal and Group with the aid of a client application used by a user when in a transmission process.

According to this procedure, however, a sender needs to create the text corresponding to the destination terminal, and hence, if sorting out a multiplicity of transmission destination terminals and Groups, the sender might set to an incorrect destination terminal. Further, a beginner using such a kind of tool might transmit the text with an incorrect text syntax and rule without being aware of it.

Therefore, the user is required to pay a careful attention to the transmission. For example, when many members in an electronic bulletin board system such as NetNews exchange the information, the members need to read local rules in depth in NetNews.

Further, for the time being, the users need to observe what is substantial in the information exchange, and to comprehend the rule in this system. Therefore, the threshold for participation seems very high to new members.

### SUMMARY OF THE INVENTION

It is a primary object of the present invention, which was devised to obviate the problems inherent in the prior art described above, to provide a technology capable of automatically modifying a text based on a syntax and a rule corresponding to a destination terminal and Group when transmitting the text, thereby relieving a load on a sender to smoothly exchange the information.

To accomplish the above object, according to one aspect of the present invention, a document modifying system (21) for transmitting a document to a predetermined destination comprises a recording unit (17) for recording a document creation standard corresponding to a destination of the document, and a modifying unit (11) for detecting a document unconformable with the document creation standard for the document destination, and modifying the document in conformity with the document creation standard.

Preferably, the document creation standard may contain a standard for a document format or a standard for a syntax of the document.

Preferably, the document may be a text transmitted by an electronic mail system or a text posted to news information service that is accumulated on a network, and the destination may be an electronic mail address of a receiving terminal of the electronic mail system, a piece of identifying information of a group including a plurality of receiving terminals, or a piece of identifying information of news group of news information service. An example of news information service is Netnews using Internet.

Preferably, the document modifying system (21) may be connected to a document transmission system for transmitting the document, and may modify the document in accordance with a command given from the document transmission system.

Preferably, the document modifying system may further comprise a communication unit (5 or 15) for transmitting the document to the destination.

According to another aspect of the present invention, a document modifying method comprises a step (S5) of identifying a destination of a document, a step (S6) of referring to a document creation standard corresponding to a destination of a document, a step (S7) of judging whether or not the document is conformable with the document creation standard for the document destination, and a step (S7) of modifying, if the document is unconformable with the document creation standard, the document in conformity with the document creation standard.

According to a further aspect of the present invention, there is provided a readable-by-computer recording medium recorded with a program executed by a computer to actualize any one of the functions given above.

As discussed above, according to the present invention, the users are able to send a proper text without being aware of the destination when creating the text. Then, the smooth communications can be performed, and a more user-friendly operation can be attained.

### BRIEF DESCRIPTION OF THE DRAWINGS

FIG. 1 is a diagram showing a system architecture of a document information transmission system in an embodiment of the present invention;

FIG. 2 is a diagram showing a hardware architecture of a user terminal 20;

FIG. 3 is a diagram showing a hardware architecture of a database server 21;

FIG. 4 is a chart showing an example of a text creation standard;

FIG. 5 is a chart showing an example of how the text is modified by the database server 21; and

FIG. 6 is a flowchart showing processing steps of the document information transmission system.

### DETAILED DESCRIPTION OF THE PREFERRED EMBODIMENT

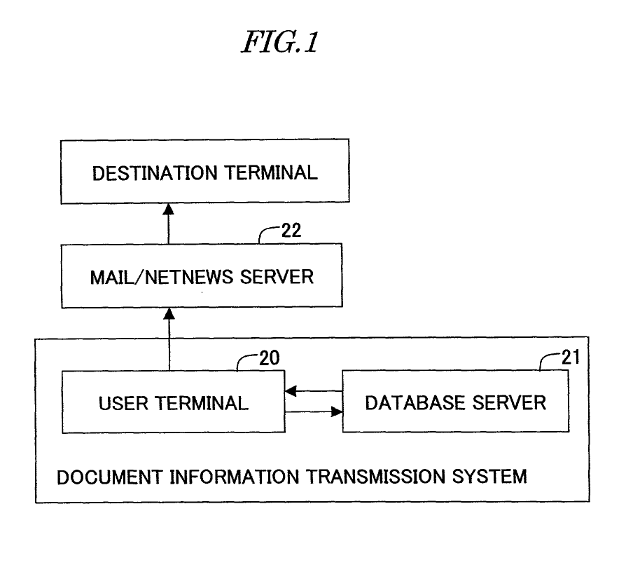

A preferred embodiment of the present invention will hereinafter be described with reference to FIGS. 1 through 6.

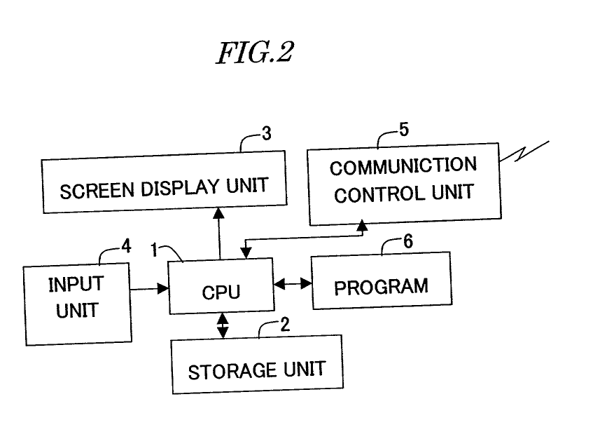

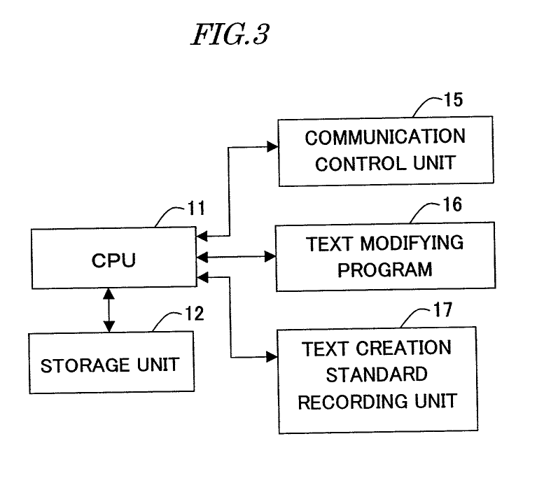

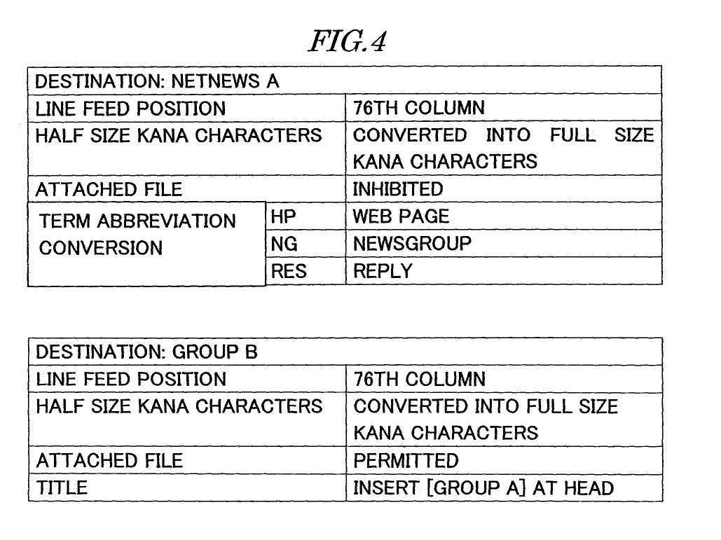

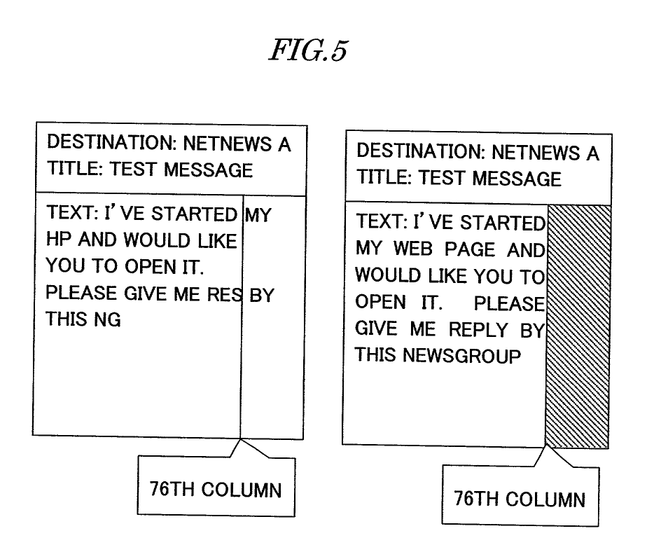

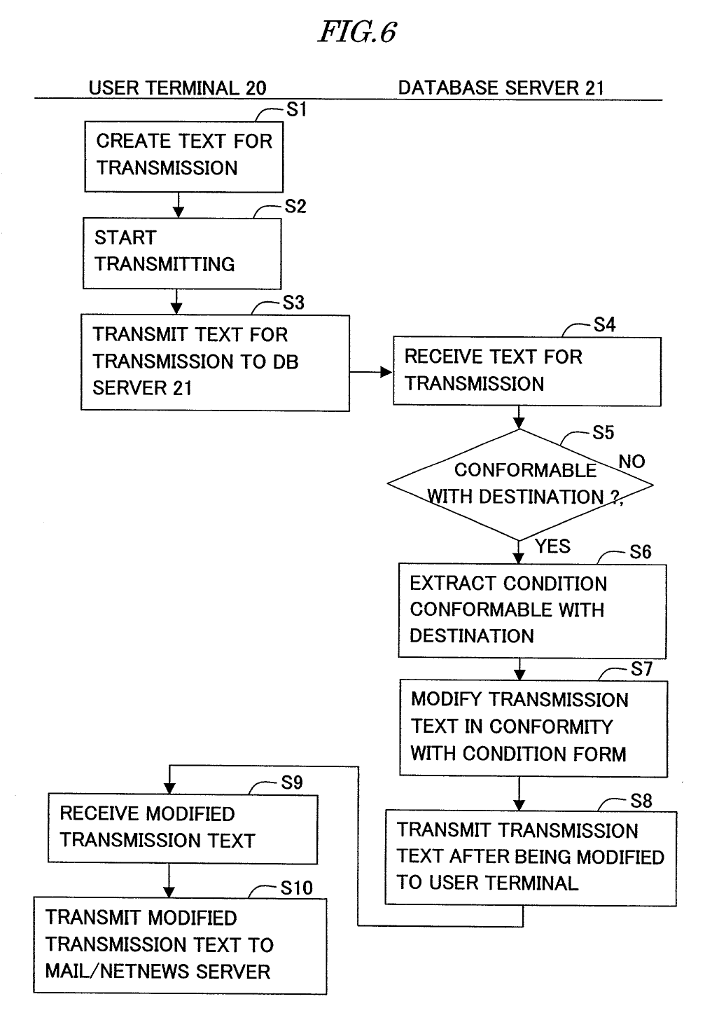

FIG. 1 is a diagram showing a system architecture of a document information transmission system in the embodiment of the present invention. FIG. 2 is a diagram showing a hardware architecture of a user terminal 20 shown in FIG. 1. FIG. 3 is a diagram showing a hardware architecture of a database server 21 shown in FIG. 1. FIG. 4 is a chart showing an example of a text creation standard saved by the database server 21. FIG. 5 is a chart showing an example of how a text is modified by the database server 21. FIG. 6 is a flowchart showing processing steps in the document information transmission system.

### System Architecture

FIG. 1 is the diagram showing the system architecture of the document information transmission system. This document information transmission system is configured by the user terminal 20 and the database server 21. The document information transmission system is connected via a network to a mail/NetNews server 22.

This document information transmission system is capable of transmitting pieces of document information to a destination terminal via the mail/NetNews server 22. Further, this document information transmission system is capable of posting an article (message) to a desired NewsGroup via the mail/NetNews server 22.

The user terminal 20 is used for creating the document information and transmitting the document information to the mail/NetNews server 22. The user terminal 20 may be exemplified such as a personal computer, a mobile information terminal (PDA: Personal Digital Assistant), a mobile telephone and so on. The user terminal 20, before transmitting the created document information to the mail/NetNews server 22, transfers the document information to the database server 21.

The database server 21 confirms a destination of the document information received. The database server 21 retains a text creation standard per destination, and therefore checks whether or not the document information conforms with the text creation standard corresponding to that destination.

Herein, the “destination” may include an individual address to which an electronic mail (so called E-mail) is delivered, an address of a group consisting of the individuals each having an address as in the case of an organization of company, an address in a mailing list and a name of NewsGroup of NetNews.

Then, the database server 21 modifies pieces of document information that do not conform with the text creation standard, and sends the modified document information back to the user terminal 20. Thereafter, the user terminal 20 transmits the sent-back document information to the mail/NetNews server 22.

The mail/NetNews server 22 is classified as a server for providing functions of both of a mail server and a NetNews server. The mail server delivers the E-mail to a destination mail server in place of a client for delivering the mail. Further, the mail server as a substitute for a client to which the mail is addressed, receives the E-mail and transfers it to the client.

The NetNews server, as on an electronic bulletin board in so-called personal computer communications (which are hereinafter abbreviated to PC communications), functions to make an in-house user write a message and further to make the in-house user read a message content.

The NetNews server may be actualized as a bulletin board in the simple PC communications. Further, the NetNews server may have a function of transferring a message posted tot he single NetNews server to one or more NetNews servers existing adjacently. NNTP (Network News Transfer Protocol) is provided for the NetNews server and known as one of application protocols of TCP/IP.

### Hardware Architecture

FIG. 2 is the diagram showing the hardware architecture of the user terminal 20. As described above, the user terminal 20 may be the PC, the PDA or the mobile telephone. The user terminal 20 includes a CPU 1 for controlling the respective components of the user terminal 20, an input unit 4 used for the user to input the information, and a screen display unit 3 for displaying the information inputted by the user from the input unit 4 and the information processed by the CPU 1. The user terminal 20 further includes a communication control unit 5 for accessing the network in response to a command given from the CPU 1, a storage unit 2 for storing a program executed by the CPU 1 and data processed by the CPU 1, and a program 6 executed by the CPU 1.

The CPU 1 executed the program stored in the storage unit 2, thereby providing a function as the user terminal 20.

The storage unit 2 is stored with the program executed by the CPU 1 and the data processed by the CPU 1.

The input unit 4 is used for inputting the information. The input unit 4 may be a keyboard, a pointing device, a push button dial etc. The pointing device is used for manipulating menus and icons displayed on the image display unit 3. What is usable as the pointing device may be a mouse, a trackball, a joystick, an electrostatic touch pad, a stick-shaped acute pointing device, or an optical pointing device.

The screen display unit 3 displays the information inputted by the users, objects such as the menus, icons etc., the E-mail text delivered from other computers, or messages posted to the mail/NetNews server 22. The screen display unit 3 may involve the use of, e.g., a CRT, a liquid crystal display and so forth.

The communication control unit 5 accesses the network in response to the command from the CPU 1 and thus communicates with the on-network servers and other user terminals.

The program includes a client program incorporating E-mail creation, display functions, NetNews display and posting functions.

FIG. 3 is the diagram showing the hardware architecture of the database server 21. The database server 21 has a CPU 11, a storage unit 12, a communication control unit 15, a text modifying program 16 and a text creation standard recording unit 17.

The CPU 11, the storage unit 12 and the communication control unit 15 are the same as those of the user terminal 20, and therefore the repetitive explanations thereof are omitted.

The text modifying program 16 is stored in the storage unit 12 and executed by the CPU 11. With this execution, the CPU 11 provides a document modifying function of the database server 21.

The text creation standard recording unit 17 is constructed of a hard disk and has text creation standards each prepared for every destination of the document. The CPU 11, when executing the text modifying program, reads the text creation standard from the text creation standard recording unit 17 and uses the creation standard as a criterion for judging the text.

### Text Creation Standard

FIG. 4 shows the example of the text creation standard retained on the text creation standard recording unit 17 by the database server 21. As already discussed above, the text creation standard recording unit 17 retains the text creation standard for every destination of the text.

FIG. 4 shows two types of text creation standards for two destinations such as a NetNews A and a Group B. The NetNews A is defined as one of NewsGroups of the NetNews. Further the Group B is defined as a group of a plurality of users receiving the E-mails. This group is recognized from a domain name defined as an E-mail address.

Referring to FIG. 4, the text creation standard for the NetNews A is given by a set of an attribute name and an attribute value. For example, the sets of the attribute names and values are shown such as Line feed position: 76th column, Half size kana character: Converted into full size kana character, and Attached file: Inhibited.

Further, term abbreviation conversions are additionally given to the NetNews A. The term abbreviation conversions are specified by couples of abbreviations and original words into which the abbreviations are converted back. For examples, the couples of abbreviations and original words into which the abbreviations are converted back, are HP: Web page, NG: NewsGroup, and Res: Reply.

As in the case of the NetNews A, the text creation standard for the Group B is given by a set of an attribute name and an attribute value. Referring to FIG. 4, for example, there are Line feed position: 76th column, Half size kana character: Converted into full size kana character, Attached file: Permitted, and Title: [Insert [Group A] at head].

For instance, “Attached file: Permitted” being specified, even if the E-mail has an attached file, this E-mail is delivered as it is. Further, with “Title: [Insert [Group A] at head] specified, [Group A] is invariably inserted at the head of a title of the E-mail to be delivered.

### Functions and Effects

FIG. 5 shows an example of how the text is modified by the database server 21. A screen on the left side in FIG. 5 shows a text before being modified. Further, a screen on the right side in FIG. 5 shows a text after being modified.

The left screen displays the not-yet-modified text of which a part extends beyond the 76th column. The database server 21 at first recognizes that a destination of the text described above is the NetNews A. Then, the database server 21 refers to the text creation standard recording unit 17 and reads a text creation standard for the NetNews A.

This text creation standard prescribes “Line feed: 76th column”, and therefore the database server 21 checks whether or not the line feed of the text is done in the 76 column position. Then, the database server 21 detects a rule-out of the line feed position of the not-yet-modified text, and modifies it as on the right screen in FIG. 5.

FIG. 6 shows the processing steps in the present document information transmission system.

To start with, the user terminal 20 creates a text for transmission as the user operates (S1).

Next, the user terminal 20 detects that the user gives an indication of transmission (S2). Then, the user terminal 20 transmits the transmission text to the database server 21 (which is shown as an abbreviation such as DB server in FIG. 6) (S3).

Then, the database server 21 receives the transmission text (S4). Subsequently, the database server 21 reads a destination of this text.

Next, the database server 21 checks whether or not a text creation standard for this destination is recorded on the text creation standard recording unit 17. This is the check as to whether or not there exists the text creation standard conformable with the destination of the text. If the text creation standard conformable with the destination is not recorded (No judgement in S5), the database server 21 advances the control to a process in S8.

Whereas if the text creation standard conformable with the destination is recorded (Yes judgement in S5), the database server 21 takes out the text creation standard conformable with the destination (S6). Herein, the text creation standard is, as shown in FIG. 4, described in the attribute-name-to-attribute-value relationship or in the abbreviation-to-original-words relationship, and is therefore called a condition form in FIG. 5.

Next, the database server 21 judges whether or not the text conforms with the creation standard. Then, if the text is not conformable with the text creation mode, the transmission text is modified based on the condition form of this text creation standard (S7).

Subsequently, the database server 21 transmits the modified transmission text to the user terminal 20 (S8).

Then, the user terminal 20 receives the modified transmission text (S9). The user terminal 20 transmits the modified transmission text to the mail/NetNews server 22 (S10).

As discussed above, according to the present document information transmission system, the document information to be transmission is transferred to the database server 21, and the text rule and syntax are checked based on the text creation standard for every destination. Accordingly, without the user being aware of, it is automatically judged whether or not the text rule and syntax are conformable with the text creation standard corresponding to the text destination. Then, the text unconformable with the text creation standard is automatically modified.

### Modified Examples

The document information transmission system in the embodiment discussed above includes the database server 21 separately from the user terminal 20. Then, the database server 21 judges whether or not the text is conformable with the text creation standard, and modifies the text unconformable with the text creation standard. The embodiment of the present invention is not, however, limited to this configuration. For example, the user terminal 20 may be provided with the text modifying program 16 and the text creation standard recording unit 17, and may modify the text.

The mail/NetNews server 22 may be provided with the text modifying program 16 and the text creation standard recording unit 17, and may modify the text requested for transmission.

Further, according to the document information transmission system in the embodiment discussed above, the user terminal 20 receives the transmission text of which the conformability has been judged and the modification has been made by the database server 21, and transmits the modified text to the original destination. Instead of this transmission mode, however, the database server 21 may transmit the judged and modified transmission text directly to the destination without sending it back to the user terminal 20.

In the embodiment discussed above, the text creation standard prescribes the attribute-name-to-attribute-value relationship and the term abbreviation conversion. The embodiment of the present invention is not, however, confined to this rule of the text creation standard. For example, an inhibited usage term conversion may be prescribed as a substitute for the term abbreviation conversion. The inhibited usage term conversion may be retained based on a rule such as Inhibited usage term: Converted term from the inhibited usage term. Further, the text creation standard may be stored in the if-then rule of the production rule.

In the embodiment discussed above, when the user gives the command to transmit the text, the text is automatically transferred to the database server 21. The embodiment of the present invention is not, however, limited to the configuration and procedure described above. For example, the user may press a check button before the transmission in order to give a command of checking and modifying the text explicitly.

### Readable-by-Computer Recording Medium

The text modifying program 16 executed by the database server 21 in the embodiment discussed above may be recorded on a readable-by-computer recording medium. Then, the computer reads and executes the program on this recording medium, whereby the text modifying function exemplified in the embodiment described above can be executed.

Further, the text modifying program 16 may be singly distributed and may also be recorded in a way of being incorporated into the program 6 of the user terminal 20 such as a client program for delivering the E-mail, a server program of the mail NetNews server 22 and so on.

Herein, the readable-by-computer recording medium embraces recording mediums capable of storing information such as data, programs, etc. electrically, magnetically, optically and mechanically or by chemical action, which can be all read by the computer. What is demountable out of the computer among those recording mediums may be, e.g., a floppy disk, a magneto-optic disk, a CD-ROM, a CD-R/W, a DVD, a DAT, an 8mm tape, a memory card, etc.

Further, a hard disk, a ROM (Read Only Memory) and so on are classified as fixed type recording mediums within the computer.

### Data Communication Signal Embodied in Carrier Wave

Furthermore, the above program may be stored in the hard disk and the memory of the computer, and downloaded to other computers via communication media. In this case, the program is transmitted as data communication signals embodied in carrier waves via the communication media. Then, the computer downloaded with this program can be made to function as the database server 21 in the embodiment discussed above.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave).

What is claimed is:

1. A document modifying system comprising:
a recording unit recording a document creation standard corresponding to a destination of a document; and
a modifying unit detecting a document unconformable with the document creation standard for the document destination, and modifying the document in conformity with the document creation standard.

2. A document modifying system according to claim 1, wherein the document creation standard contains a standard for a document format or a standard for a syntax of the document.

3. A document modifying system according to claim 1, wherein the document is a text transmitted by an electronic mail system or a text posted to news information service that is accumulated on a network, and
the destination is an electronic mail address of a receiving terminal of the electronic mail system, a piece of identifying information of a group including a plurality of receiving terminals, or a piece of identifying information of news group of the information service.

4. A document modifying system according to claim 1, wherein said document modifying system is connected to a document transmission system transmitting the document, and modifies the document in accordance with a command given from said document transmission system.

5. A document modifying system according to claim 1, further comprising a communication unit transmitting the document to the destination.

6. A document modifying method comprising:
identifying a destination of a document;
referring to a document creation standard corresponding to a destination of a document;
judging whether or not the document is conformable with the document creation standard for the document destination; and
modifying, if the document is unconformable with the document creation standard, the document in conformity with the document creation standard.

7. A document modifying method according to claim 6, wherein the document creation standard contains a standard for a document format or a standard for a syntax of the document.

8. A document modifying method according to claim 6, wherein the document is a text transmitted by an electronic mail system or a text posted to news information service that is accumulated on a network, and
the destination is an electronic mail address of a receiving terminal in the electronic mail system, a piece of identifying information of a group including a plurality of receiving terminals, or a piece of identifying information of news group of the news information service.

9. A document modifying method according to claim 6, further comprising transmitting the document to the destination.

10. A storage medium readable by a machine, tangible embodying a program of instructions executable by the machine to perform method steps comprising:
identifying a destination of a document;
referring to a document creation standard corresponding to a destination of a document;
judging whether or not the document is conformable with the document creation standard for the document destination; and
modifying, if the document is unconformable with the document creation standard, the document in conformity with the document creation standard.

11. A storage medium readable by a machine tangible embodying a program according to claim 10, wherein the document creation standard contains a standard for a document format or a standard for a syntax of the document.

12. A storage medium readable by a machine tangible embodying a program according to claim 10, wherein the document is a text transmitted by an electronic mail system or a text posted to news information service that is accumulated on a network, and
the destination is an electronic mail address of a receiving terminal of the electronic mail system, a piece of identifying information of a group including a plurality of receiving terminals, or a piece of identifying information of news group of news information service.

13. A storage medium readable by a machine tangible embodying a program according to claim 10, of instructions executable by the machine, the method steps further comprising transmitting the document to the destination.

14. A storage medium readable by a machine, tangible embodying a program of instructions executable by the machine to perform method steps comprising:
a transmission device transmitting a document to a specified destination; and
a document modifying system including a recording unit recording a document creation standard corresponding to the destination of the document, and a modifying unit detecting a document unconformable with the document creation standard for the document destination and modifying the same document in accordance with the document creation standard,
wherein said document modifying system receives the document transmitted by said transmission device, and modifies the document unconformable with the document creation standard.
